(19) United States
(12) Patent Application Publication
(10) Pub. No.: US 2020/0151673 A1
(43) Pub. Date: May 14, 2020

(54) SYSTEM AND METHOD FOR AN INTERACTIVE WEB SITE FOR SCHEDULING HAIRCUTS

(71) Applicant: Anna Palko, Midland, TX (US)

(72) Inventor: Anna Palko, Midland, TX (US)

(21) Appl. No.: 16/655,154

(22) Filed: Oct. 16, 2019

Related U.S. Application Data
(60) Provisional application No. 62/746,018, filed on Oct. 16, 2018.

(51) Int. Cl. G06Q 10/10; G06F 16/9538; G06F 16/9035; G06F 16/9535; G06F 16/9537

(52) U.S. Cl. CPC G06Q 10/1095; G06F 16/9538; G06F 16/9537; G06F 16/9535; G06F 16/9035

(57) ABSTRACT

A system, method and computer readable medium for scheduling a haircut on a web site are disclosed.

### CROSS-REFERENCE TO RELATED PATENT APPLICATIONS

This patent application is based on and claims priority from US Provisional Patent Application filed by Anna Palko on Oct. 16, 2018 entitled SYSTEM AND METHOD FOR A MOBILE APPLICATION FOR ON-SITE HAIRCUTS and assigned Ser. No. 62/746,018, which is hereby incorporated by reference in its entirety.

### SUMMARY OF THE INVENTION

An illustrative embodiment of a web site for scheduling on-site haircuts is disclosed herein.

### BRIEF DESCRIPTION OF THE DRAWINGS

FIG. 1 is a schematic depiction of an illustrative embodiment of a system for on-site haircuts; and

FIG. 2 is a flow chart of an illustrative embodiment of a system, method and computer readable medium for on-site haircuts;

FIG. 3 is a flow chart of an illustrative embodiment of a system, method and computer readable medium for on-site haircuts;

FIG. 4 is screen presentation of a graphical user interface of an illustrative embodiment of a system, method and computer readable medium for on-site haircuts;

FIG. 5 is screen presentation of a graphical user interface of an illustrative embodiment of a system, method and computer readable medium for on-site haircuts;

FIG. 6 is screen presentation of a graphical user interface of an illustrative embodiment of a system, method and computer readable medium for on-site haircuts;

FIG. 7 is screen presentation of a graphical user interface of an illustrative embodiment of a system, method and computer readable medium for on-site haircuts;

FIG. 8 is screen presentation of a graphical user interface of an illustrative embodiment of a system, method and computer readable medium for on-site haircuts;

FIG. 9 is screen presentation of a graphical user interface of an illustrative embodiment of a system, method and computer readable medium for on-site haircuts;

FIG. 10 is screen presentation of a graphical user interface of an illustrative embodiment of a system, method and computer readable medium for on-site haircuts;

FIG. 11 is screen presentation of a graphical user interface of an illustrative embodiment of a system, method and computer readable medium for on-site haircuts;

FIG. 12 is a schematic depiction of a data structure of an illustrative embodiment of a system, method and computer readable medium for on-site haircuts;

FIG. 13 is a schematic depiction of a data structure of an illustrative embodiment of a system, method and computer readable medium for on-site haircuts;

FIG. 14 is a schematic depiction of a flow chart of functions performed by a computer program in a server processor in an illustrative embodiment of a system, method and computer readable medium; and

FIG. 15 is a schematic depiction of a flow chart of functions performed by a computer program in a server processor in an illustrative embodiment of a system, method and computer readable medium.

### DETAILED DESCRIPTION OF AN ILLUSTRATIVE EMBODIMENT OF THE INVENTION

In a particular illustrative embodiment of the invention, a system and method are provided. The system the includes but is not limited to an application comprising a computer program stored in a computer readable medium on a server processor that presents a graphical user interface to clients and service providers. The method is performed by executing the computer program on the server processor. In a particular illustrative embodiment, the system and method provide barbers an opportunity to work for themselves on their time without paying booth fee weekly inside a shop, by contracting themselves out through the web site and graphical user interface provided by the system and method. The system and method enable the participating barbers using the system and method to gain clientele they may have not had the opportunity to gain.

The system and method provide the community of potential clientele the option to get their haircut right where they are at, at any time of day by a service provider such as a barber or personal care provider. This saves a client from the trouble of going into a barbershop and waiting an hour (+) to receive a haircut or personal care. Clients use the system and method to locate an available barber in their area and have the barber come cut their hair at their desired location and at their desired time. The clients are provided an account which stores the client preference data for each client comprising their credit card hooked up to it or will give them the option to NOT use their card but to select “pay with cash”. This will allow easy transactions between the client and barber.

In a particular illustrative embodiment, barbers will be registered and contracted through the system and method and will be able to set themselves to a status, either [AVAILABLE] or [UNAVAILABLE]. Based on the location of the potential client accessing the graphical user interface to request a service, in the case of a haircut, service providers, barbers who are available for the service will pop up in the system and method, on a user's mobile device or computer. The client will be available to choose a barber based on location, time, service provider rating and price. The client will also be able to track they route of the barber whom they choose as he is on the way to their chosen location for providing the service.

The client is provided the ability to rate and tip on the graphical user interface, and even designation a particular service provider as a *FAVORITE* barber, and book future appointments with the service through the graphical user interface presented to the clients and service providers. Clients will also be able to pick a barber and destination in advance.

Users will be able to pick from different haircut styles such as by clicking on a Style field on the graphical user interface provided by the server processor, comprising styles:

Straight Razor, Fade, Taper, Scissor Cut, Hard Part, Beard Trim, Waxing (Full Body, Eyebrows, Face, etc.), Scalp Massage, Neck Massage, body massages and facials depending on the availability of service providers.

The following are target audiences for the system and method: Colleges, Businesses, Barber Schools, Barber Shops, Corporate Offices and Oilfield Man Camps. There is a supply and demand for the system and method based on the following statistics. Midland, Tex. number of barber shops: 47 number of barber schools: 1; Odessa, Tex. number of barber shops: 31 number of barber schools: 1; Dallas, Tex. number of barber shops: 50+ number of barber schools: 20+; Austin, Tex. number of barber shops: 100+ number of barber schools: 9.

The system and method are game changing for many reasons. The inventor strongly believes, from experience as a barbershop owner, that people would prefer the convenience of getting a cut at their desired location, being their house, workplace, dorm, etc. It is super convenient for the client! Vice versa, barbers would prefer working for themselves, without the hassle of paying $200.00 a week in booth rent to a business that they have to confine to their rules. It is a win-win situation for barbers and clients in the United States!

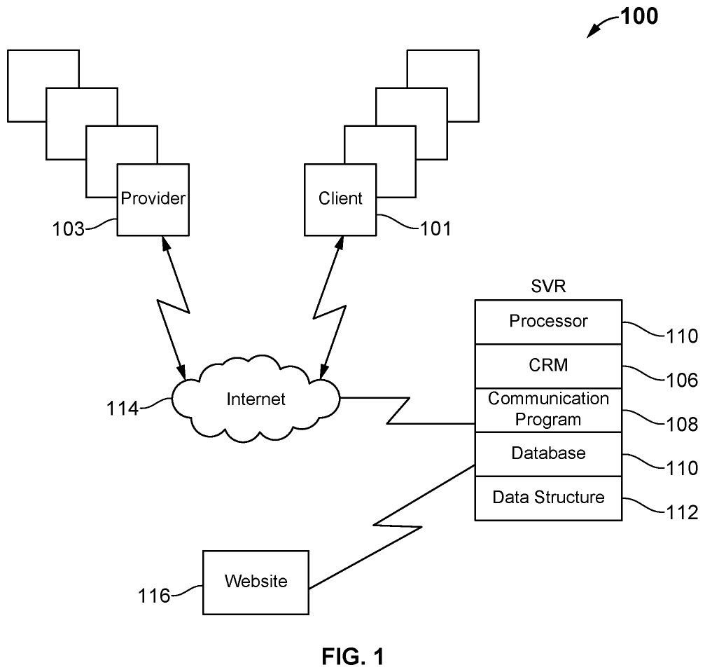

Turning now to FIG. 1, in a particular illustrative embodiment of the invention 100, a server processor 110 is provided that contains a computer readable medium 106 containing a computer program 108 including instructions that are executed by the server processor. The computer program provides a Graphical User Interface (GUI) as a portal to a Web Site 116 hosted on the server containing a computer program, such as a web site on the internet 114 World Wide Web that enables a client user processor 101 and/or a service provider processor 103 user to sign on to use the system and method of the present invention. A user such a client that wants to schedule a haircut or other services signs on to schedule a time and location for the provision of services, such as a haircut.

The client user signs onto the website 116 through a graphical user interface using a desk top computer 101 or a mobile device, such as a smart phone. The client user accesses the web site on the world wide web and enters client preference data using the graphical user interface for the web site provided by the server processor. A client logs onto the website via the graphical user interface on the web site 116, selects a desired service listed on the web site and sends a service request, such as a haircut request through the graphical user interface to the server processor 110.

The server processor also includes but is not limited to a non-transitory computer readable medium 106, a computer program 108 comprising instructions that are executed by the server processor 110 is enabled through the server to access a data base of provider preference data stored on the server in a client provider preference data structure stored in the database on the server processor non-transitory computer readable medium. The user can select a particular service provider such as a barber based on the barber's hair styles available, location availability and time availability.

A service provider also logs onto the system to enter the server provider preference data including but not limited to hair styles provided, services provided, available times, rating and available location. The provider information is stored in a service provider data structure in the data base on the server. Once the provider is scheduled by the user, payment is made using a pay portal provided on the server. The provider is a hair stylist, masseuse, or other service provider entered into the provider preference data in the data base.

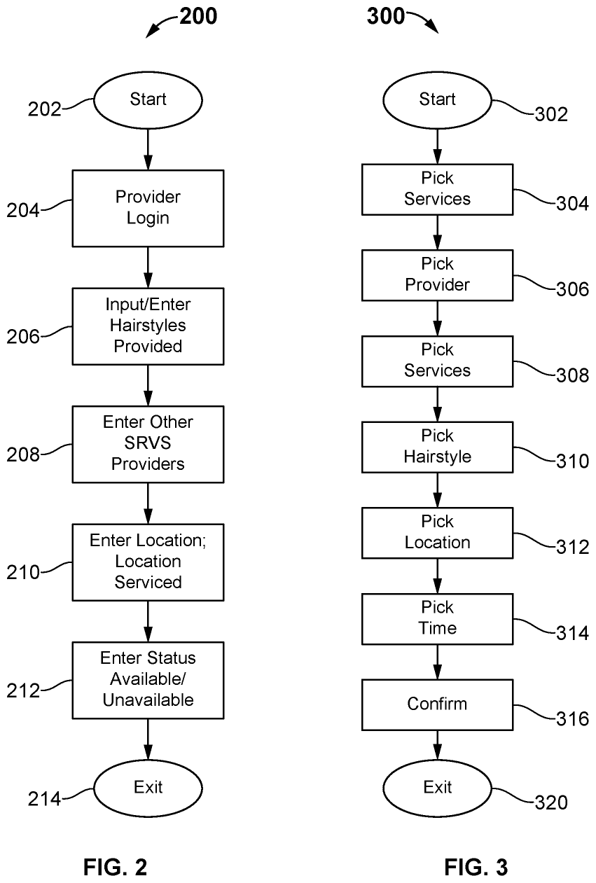

Turning now to FIG. 2, a flow chart of functions is illustrated, wherein the flow chart of functions starts at 202. At 204 a service provider accesses the graphic user interface for the web site which is hosted on the server processor. The provider at 206 enters hair styles provided. At 208 the provider enters other services offered including but not limited to the services listed above. At 210 the provider enters locations serviced. At 212 the provide enters their status as “Unavailable” or “Available” for providing each of services and which services are available and at which location. The service provider enters their services available such as hair styles provided and locations, including but not limited to on-site on-demand cutting wherein the barber travels to the client's location on demand from the client. The service provider enters other services provided by the service provider in addition to or in lieu of the hair styles provided by the service provider. For example, a service provider may provide only haircuts or may provide only massages. The service provider enters locations for each of the services provided by the service provider and the current availability status, AVAILABLE or UNAVAILABLE. The flow chart of provider functions ends at 214.

Turning now to FIG. 3, a flow chart of functions is illustrated, wherein the flow chart of functions starts at 302. At 304 a client accesses a graphical user interface for the web site presented by the server processor at a registered uniform resource locator (URL) for example, www.mocuts.com. the client logs onto the web site via the graphical user interface and into the server computer program on the server and picks services desired from a client graphical user interface presented on the web site to the client processor by the server computer. A list of service providers that are available for the service requested are listed on a graphical user interface screen and presented to the client on the client processor. The client at 306 picks a provider that is currently available to provide the desired service. At 308 the client selects services offered by the available provider. At 310 the client selects a hair style offered by the provider on the graphical user interface. The client enters locations desired at 312 and picks a time for the service to be provided at the location at 314. The appointment between the provider and the client is confirmed at 316 and presented on the client graphical user interface on the web site and to the provider on the provider graphical user interface. The flow chart of provider functions ends at 320.

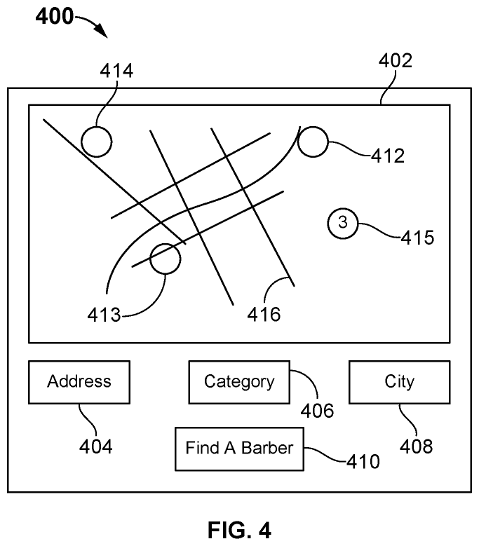

Turning now to FIG. 4, in a particular illustrative embodiment of the invention, a series of graphical user interface screens are schematically depicted as presented on the graphical user interface to client processors and service provider processor. The web site users are either a client or a service provider. As shown in FIG. 4, in an illustrative embodiment of the invention, the server processor accesses the data for provider preferences and client preferences from the data base and presents a Home screen 400 to a client. The GUI presents a local map 402 showing roads. A field 415 indicates the number of featured barber shop locations near the client's location. Additional barbers that are available to provide a requested service at your requested location are also presented at a search result for barbers, discussed below. Client criteria is entered by clicking on the web site fields for address 404, category of service 406 and city 408. Clicking on the Find a Barber tab 410 activates a search for barbers that are service providers meeting the client's entered client preferences. Once the client has entered their client preferences, the home fields for address, category and city are populated with the client's preferences from the data base.

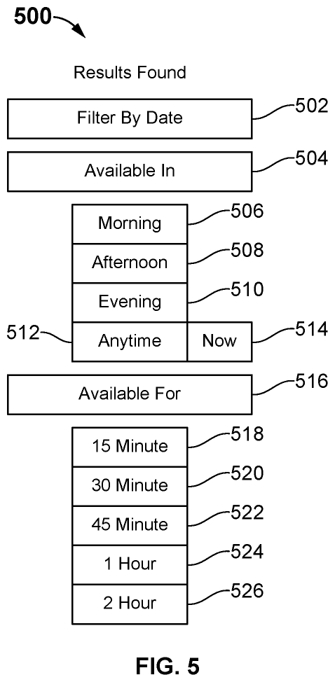

Turning now to FIG. 5, in a particular illustrative embodiment of the invention, a results found page 500 is presented to the client after the client at the client processor clicks on the field Find a Barber 410 on the web site client GUI The “find a barber” results can be filtered by date available by clicking on GUI field 502. A client clicks on GUI field 504 to select a desired available time from a drop down menu 506 Morning, 508 Afternoon, 510 Evening, 512 Any Time and 514 Now. A client clicks on GUI field 516 to select from an item from a drop down menu 518 15 Minutes, 520 30 Minutes, 522 45 Minutes, 524 1 Hour and 526 2 Hours.

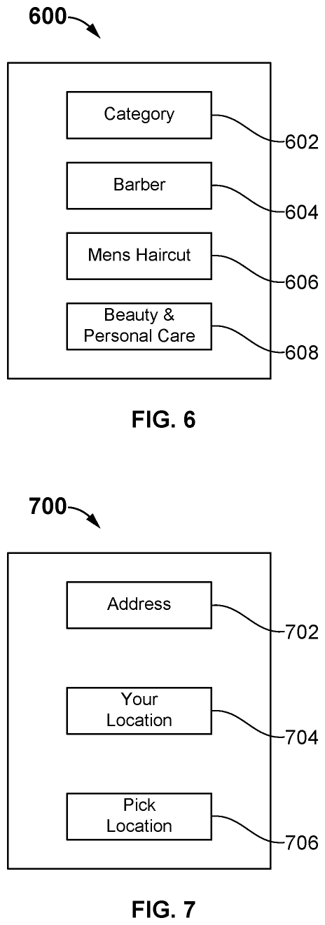

Turning now to FIG. 6, in a particular illustrative embodiment of the invention, a category 602 GUI field when clicked presents a GUI field 604 to select a barber, presents a GUI field 606 to select a man's haircut and presents a GUI field 608 to select a barber from the categories presented by the client GUI.

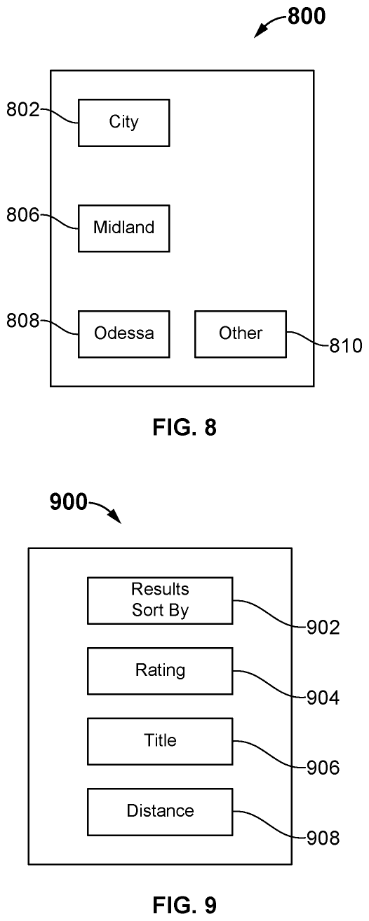

Turning now to FIG. 7, in a particular illustrative embodiment of the invention, an address 702 GUI field when clicked presents a GUI field 704 to select the client's location, presents a GUI field 706 to select a different location than the client's location. Turning now to FIG. 8, in a particular illustrative embodiment of the invention, a city 802 GUI field when clicked presents a GUI fields 806, 808 and 810 to select a city presented in the GUI field or 810 to select another city not presented by the GUI.

Turning now to FIG. 9, in a particular illustrative embodiment of the invention, a sort results by 902 GUI field is presented on the client GUI when the client clicks on sort results, presents a GUI fields 904, 906 and 908 to select a sorting order for the search results to be sorted by ration 904, title of barber shop 906 and distance from client 908.

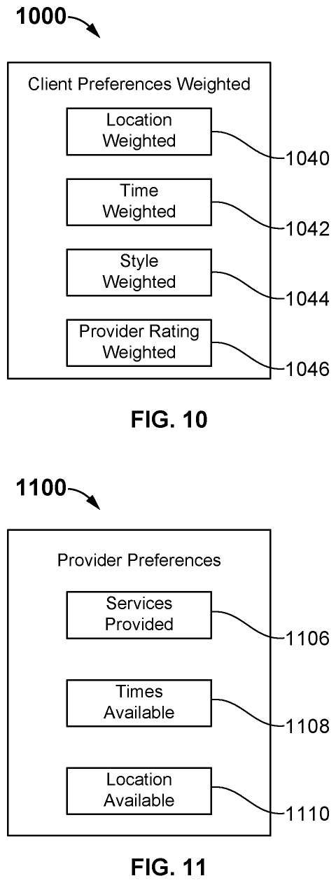

Turning now to FIG. 10, in a particular illustrative embodiment of the invention, a client preferences GUI screen is presented to the client form the client GUI. The computer program in the server processor correlates the client preference data for the client with service providers preference data as follows. The server processor correlates the client preference data and provider preference data by multiplying the client preference The client preference data is divided into client preference data categories including but not limited to time, rating, location (distance between client and provider), style, adjusted time value and adjusted distance value. The server calculates a correlation score for the providers. The distance value is adjusted by the equation (5.0)/(distance to provider location value) =adjusted distance value (ADV). The provider location value is the distance from provider location to client location). The time value is adjusted by the equation (5.0)/(time duration in hours until the provider is available)=adjusted time value (ATV). The provider location value is the distance from provider location to client location). The client at a client processor enters a weight of importance for the client preference data values for client preference location 1040, time 1042, style 1044 and provider rating 1046. The client enters data from the client processor into the client GUI and assigns a weight from 1.00 to 5.00 for each of the client preference data categories values for location, rating, time and style. The weights are used to correlate the client preference data with the provider preference data and to sort the Find a Barber search results based on the correlation of the client preferences and provider preferences.

The correlation performed by the server processor multiples the client preference data values for weights for time, rating, location (distance) and style respectively by the adjusted time value (ATV), provider rating value, adjusted distance value (ADV) and provider style value. The correlation score for a service provider=(client preference data weight for time)×(ATV)+(client preference data weight for service provider rating)×(provider rating value)+(client preference data weight for location (distance between client and service provider))×(ADV)+client preference data weight for style x provider preference data style value.

The server processor then confirms an appointment with the service provider having the highest correlation score. When the client request more than one provider the server processor ranks the correlation scores in descending order and presents them on the client GUI for selection of a provider by the client. The server then confirms the service appointment after the client has selected one of the ranked service providers presented on the client GUI.

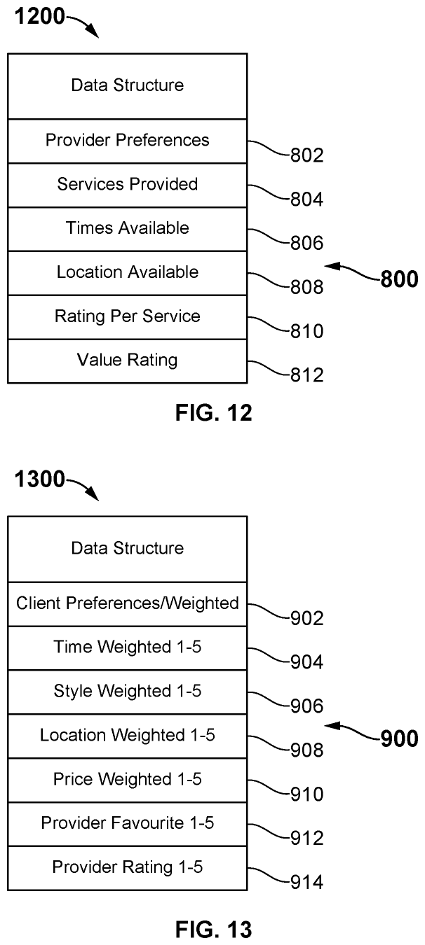

Turning now to FIG. 11, in a particular illustrative embodiment of the invention, the GUI presents a web site page to a provider to enter provider preference data 1106 for services provided, times available 1106 and location available 1110. A service provider enters the provider preference data through the GUI and the server processor stores the service provider data into the service provider data structure on the server data base. Turning now to FIG. 12, in a particular illustrative embodiment of the invention, a data structure 1200 comprising fields for storing data in the computer readable medium containing the data structure. A provider preferences field 802, services provided 804, times available 806, location available 808, rating per service offered 810 and a value retaining 812 equal to the cost of the service divided by the rating of 1.0 to 5.0 for the service.

Turning now to FIG. 13, in a particular illustrative embodiment of the invention, a data structure 1300 comprising fields for storing data in the computer readable medium containing the data structure. A client preferences field 902, time weight of 1.0 to 5.0 804, style weight of 1.0 to 5.0 906, location weight of 1.0 to 5.0 908, price weight of 1.0 to 5.0 910, provider favorite weight of 1.0 to 5.0 912 and provider rating weight of 1.0 to 5.0 914 and a value retaining 812 equal to the cost of the service divided by the rating of 1.0 to 5.0 for the service.

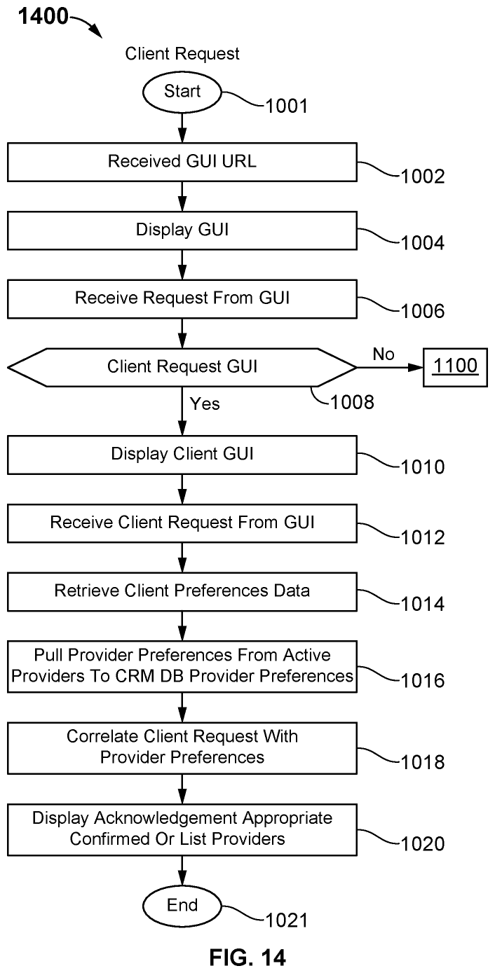

Turning now to FIG. 14, a flow chart of functions performed by the computer program executed by the server web processor in a particular illustrative embodiment 1400 of the invention is depicted. The functions flow chart starts at 1001. At 1002 the server computer program presents the GUI and at 1004 receives a URL from the data base and displays the GUI at the URL. At 1006 the computer program receives a request from the GUI. at 1008 the computer program determines if request is a client request. If yes, the computer program displays the client GUI at 1010. At 1012 the computer program receives a client request from the client GUI presented on the web site at the URL location on the world wide web. At 1014 the computer program retrieves client preference data. At 1016, upon receiving a request for service from a client request the computer program issues a pull command to all registered providers to update their provider preference data. At 1018 the computer program correlates the client request with the provider preferences. At 1020 the computer program presents a client confirmed appointment on the client GUI. The functional flow chart ends at 1021.

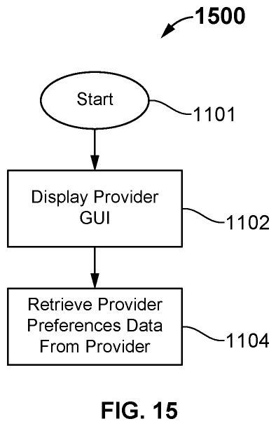

Turning now to FIG. 15, a flow chart of functions performed by the computer program executed by the server web processor in a particular illustrative embodiment 1500 of the invention is depicted. The functions flow chart starts at 1101. At 1102 the server computer program presents the service provider GUI and at 1104 retrieves the provider preference data for the provider and displays the provider preference data on GUI on the web site at the URL.

A particular illustrative embodiment of the invention is disclosed as a system for scheduling a haircut, the system comprising: a web site server connected to the internet, wherein the server comprises a web site processor, a computer readable medium and a data structure stored in the computer readable medium; a graphical user interface hosted on the web site server for sending and receiving client preference data from a client processor and provider preference data from a plurality of service provider processors; a server data base that receives the client preference data and service provider data from the graphical user interface; a data structure wherein the server processors stores the client preference data and provider preference data; a pull request command sent by the server processor to plurality of the plurality of service provider processors when the server processor receives a service request message from the client processor through the graphical user interface, wherein the server processor sends the pull request to the plurality of service provider processors to cause the plurality service provider processors to respond to the pull request by sending updated service provider data to the server; and a service appointment confirmation presented on the web site graphical user interface confirming an appointment with one of the plurality of service providers provider preference data based on a correlation score of the client preference data and the service provider the updated service provider data.

In another particular illustrative embodiment of the invention, in the system the service provider data comprises categories for availability times, availability locations, services offered and price of service. In another particular illustrative embodiment of the invention, in the system the client preference data comprises client preference data categories comprising availability times, preferred locations, preferred service and price. In another particular illustrative embodiment of the invention, in the system each of the client preference data categories data are weighted by a client at the client processor, wherein the weights range numerically from 1.0 to 5.0 based on the importance of the service provider categories to the client and, wherein each of the client preference data and wherein the server processor correlates the service provider data with the client preference data categories to select a service provider to fulfil the client service request. In another particular illustrative embodiment of the invention, the server processor ranks the service providers in order based a strength of the correlation of the service provider data categories and the client preference data categories and presents a top 5 service providers based on the ranks.

In another particular illustrative embodiment of the invention, in the system the service provider processor receives a client selection of one of the plurality of service providers to a selected service provider and presents a confirmation of appointment on the client graphical user interface. In another particular illustrative embodiment of the invention, in the system, the service provider processor sends a confirmation of appointment to the client processor and displays the appointment on the client graphical user interface. In another particular illustrative embodiment of the invention, in the system the correlation score is calculated by the equation, correlation score=(client preference data weight for time)×(ATV)+(client preference data weight for service provider rating)×(provider rating value)+(client preference data weight for location (distance between client and service provider))×(ADV)+client preference data weight for style x provider preference data style value.

In another particular embodiment of the invention, a method is disclosed for scheduling a haircut, the system including but not limited to presenting a graphical user interface hosted on the web site server for sending and receiving client preference data from a client processor and provider preference data from a plurality of service provider processors; receiving at a server data base the client preference data and service provider data from the graphical user interface; storing by the server processor the client preference data and provider preference data in a data structure; sending a pull request command sent by the server processor to plurality of the plurality of service provider processors when the server processor receives a service request message from the client processor through the graphical user interface, wherein the server processor sends the pull request to the plurality of service provider processors to cause the plurality service provider processors to respond to the pull request by sending updated service provider data to the server; and sending a service appointment confirmation message to the client processor confirming an appointment with one of the plurality of service providers provider preference data based on a correlation score of the client preference data and the service provider the updated service provider data.

In another particular illustrative embodiment of the invention, in the method the service provider data comprises categories for availability times, availability locations, services offered and price of service. In another particular illustrative embodiment of the invention, in the method the client preference data comprises client preference data categories comprising availability times, preferred locations, preferred service and price. In another particular illustrative embodiment of the invention, in the method each of the client preference data categories data are weighted by a client at the client processor, wherein the weights range numerically from 1.0 to 5.0 based on the importance of the service provider categories to the client and, wherein each of the client preference data and wherein the server processor correlates the service provider data with the client preference data categories to select a service provider to fulfil the client service request. In another particular illustrative embodiment of the invention, in the method the server processor ranks the service providers in order based a strength of the correlation of the service provider data categories and the client preference data categories and presents a top 5 service providers based on the ranks.

In another particular illustrative embodiment of the invention, in the method the service provider processor receives a client selection of one of the plurality of service providers to a selected service provider and presents a confirmation of appointment on the client graphical user interface. In another particular illustrative embodiment of the invention, in the method the service provider processor sends a confirmation of appointment to the client processor and displays the appointment on the client graphical user interface. In another particular illustrative embodiment of the invention, in the method the correlation score is calculated by the equation, correlation score=(client preference data weight for time)×(ATV)+(client preference data weight for service provider rating)×(provider rating value)+(client preference data weight for location (distance between client and service provider))×(ADV)+client preference data weight for style×provider preference data style value.

In another particular illustrative embodiment of the invention a computer readable medium is disclosed including but not limited to a computer program stored in a computer readable medium comprising instructions executed by a server processor, the computer program further including but not limited to instructions to present a graphical user interface hosted on the web site server for sending and receiving client preference data from a client processor and provider preference data from a plurality of service provider processors; instructions to receive at a server data base the client preference data and service provider data from the graphical user interface; instructions to store by the server processor the client preference data and provider preference data in a data structure; instructions to send a pull request command sent by the server processor to plurality of the plurality of service provider processors when the server processor receives a service request message from the client processor through the graphical user interface, wherein the server processor sends the pull request to the plurality of service provider processors to cause the plurality service provider processors to respond to the pull request by sending updated service provider data to the server; and instructions to send a service appointment confirmation message to the client processor confirming an appointment with one of the plurality of service providers provider preference data based on a correlation score of the client preference data and the service provider the updated service provider data.

In another particular illustrative embodiment of the invention, in the medium the service provider data comprises categories for availability times, availability locations, services offered and price of service, wherein the client preference data comprises client preference data categories comprising availability times, preferred locations, preferred service and price and wherein each of the client preference data categories data are weighted by a client at the client processor, wherein the weights range numerically from 1.0 to 5.0 based on the importance of the service provider categories to the client and, wherein each of the client preference data and wherein the server processor correlates the service provider data with the client preference data categories to select a service provider to fulfil the client service request.

In another particular illustrative embodiment of the invention, in the medium the server processor ranks the service providers in order based a correlation score for the service provider data categories and the client preference data categories and presents a top 5 service providers based on the correlation scores. In another particular illustrative embodiment of the invention, in the medium the service provider processor receives a client selection of one of the plurality of service providers to a selected service provider and presents a confirmation of appointment on the client graphical user interface.

The present inventions can be realized in hardware, software, or a combination of hardware and software. In a specific embodiment, a system according to the present inventions can be realized in a centralized fashion in one computer system, or in a distributed fashion where different elements are spread across several interconnected computer systems. Any kind of computer system or other apparatus adapted for carrying out the methods and inventions described herein may be used for purposes of the present inventions. A typical combination of hardware and software could be a general-purpose computer system with a computer program that, when being loaded and executed, controls the computer system such that it carries out the methods and inventions described herein.

The figures herein include block diagram and flowchart illustrations of methods, apparatus(s) and computer program products according to various embodiments of the present inventions. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus may be used to implement the functions specified in the block, blocks or flow charts. The flow chart is an example only and the steps shown in the flow chart need not be executed in the exact order shown on the flow chart. Moreover, some of the steps in the flow chart can be left out in performing the system and method of the present invention. These computer program instructions may also be stored in a computer-readable medium or memory that can direct a computer or other programmable data processing apparatus to function in a particular manner, such that the instructions stored in the computer-readable medium or memory produce an article of manufacture including instructions which may implement the function specified in the block, blocks or flow charts. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block, blocks or flow chart. Those skilled in the art should readily appreciate that programs defining the functions of the present inventions can be delivered to a computer in many forms, including but not limited to: (a) information permanently stored on non-writable storage media (e.g., read only memory devices within a computer such as ROM or CD-ROM disks readable by a computer I/O attachment); (b) information alterably stored on writable storage media (e.g., floppy disks and hard drives); or (c) information conveyed to a computer through communication media for example using wireless, baseband signaling or broadband signaling techniques, including carrier wave signaling techniques, such as over computer or telephone networks via a modem, or via any of the networks known. A diagram is shown illustrating an example of a computer that may be used in connection with the present inventions. The computer may include at least one processor and at least one memory, each of which may be coupled to a local interface or bus. An operating system may be stored in the memory and executable by the processor. Any variety of software programs may also be stored in the memory and executable by the processor. In a specific embodiment, examples of programs that may be stored in the memory and executable by the processor. A media player application may be stored in the memory and executable by the processor. Also stored in the memory may be various forms of data. The term “executable” as used herein means that a program file is of the type that may be run by the processor. In specific embodiments, examples of executable programs may include without limitation: a compiled program that can be translated into machine code in a format that can be loaded into a random access portion of the memory and run by the processor; source code that may be expressed in proper format such as object code that is capable of being loaded into a random access portion of the memory and executed by the processor; or source code that may be interpreted by another executable program to generate instructions in a random access portion of the memory to be executed by the processor. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components. The memory may include both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device. In a specific embodiment, the processor may represent multiple processors and/or multiple processor cores and the memory may represent multiple memories that operate in parallel processing circuits, respectively. In such a case, the local interface may be an appropriate network that facilitates communication between any two of the multiple processors, between any processor and any of the memories, or between any two of the memories. The local interface may comprise additional systems designed to coordinate this communication, including, for example, performing load balancing. The processor may be of electrical or of some other available construction. Although the programs and other various systems, components and functionalities described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components. Such technologies are generally well known by those skilled in the art and, consequently, are not described in detail herein. The flowchart shows the functionality and operation of various specific embodiments of certain aspects of the present inventions. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s). Although the flowchart shows a specific order of execution, it is understood that the order of execution may differ from that which is depicted. For example, the order of execution of two or more blocks may be scrambled relative to the order shown. Also, two or more blocks shown in succession may be executed concurrently or with partial concurrence. Further, in some embodiments, one or more of the blocks shown in flow chart, may be skipped or omitted. In addition, any number of counters, state variables, warning semaphores, or messages might be added to the logical flow described herein, for purposes of enhanced utility, accounting, performance measurement, or providing troubleshooting aids. It is understood that all such variations are within the scope of the present inventions. Any logic or application described herein that comprises software or code can be embodied in any non-transitory computer-readable medium, such as computer-readable medium, for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present inventions, a “computer-readable medium” may include any medium that may contain, store, or maintain the logic or application described herein for use by or in connection with the instruction execution system.

The computer-readable medium may comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random-access memory (RAM) including, for example, static random-access memory (SRAM) and dynamic random-access memory (DRAM), or magnetic random-access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device. The computer may further include a network interface coupled to the bus and in communication with a network. The network interface may be configured to allow data to be exchanged between computer and other devices attached to the network or any other network or between nodes of any computer system or the video system. In addition to the above description of the network, it may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, the network interface may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol. The computer may also include an input/output interface coupled to the bus and also coupled to one or more input/output devices, such as a display, a touchscreen, a mouse or other cursor control device, and/or a keyboard. In certain specific embodiments, further examples of input/output devices may include one or more display terminals, keypads, touchpads, scanning devices, voice or optical recognition devices, or any other devices suitable for entering or accessing data by one or more computers. Multiple input/output devices may be present with respect to a computer or may be distributed on various nodes of computer system, the system and/or any of the viewing or other devices. In some embodiments, similar input/output devices may be separate from the computer and may interact with the compute or one or more nodes of computer system through a wired or wireless connection, such as through the network interface. It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A system for scheduling a haircut, the system comprising:
a web site server connected to the internet, wherein the server comprises a web site processor, a computer readable medium and a data structure stored in the computer readable medium;
a graphical user interface hosted on the web site server for sending and receiving client preference data from a client processor and provider preference data from a plurality of service provider processors;
a server data base that receives the client preference data and service provider data from the graphical user interface;
a data structure wherein the server processors stores the client preference data and provider preference data;
a pull request command sent by the server processor to plurality of the plurality of service provider processors when the server processor receives a service request message from the client processor through the graphical user interface, wherein the server processor sends the pull request to the plurality of service provider processors to cause the plurality service provider processors to respond to the pull request by sending updated service provider data to the server; and
a service appointment confirmation presented on the web site graphical user interface confirming an appointment with one of the plurality of service providers provider preference data based on a correlation score of the client preference data and the service provider the updated service provider data.

2. The system of claim 1, wherein the service provider data comprises categories for availability times, availability locations, services offered and price of service.

3. The system of claim 2, wherein the client preference data comprises client preference data categories comprising availability times, preferred locations, preferred service and price.

4. The system of claim 3, wherein each of the client preference data categories data are weighted by a client at the client processor, wherein the weights range numerically from 1.0 to 5.0 based on the importance of the service provider categories to the client and, wherein each of the client preference data and wherein the server processor correlates the service provider data with the client preference data categories to select a service provider to fulfil the client service request.

5. The system of claim 4, wherein the server processor ranks the service providers in order based a strength of the correlation of the service provider data categories and the client preference data categories and presents a top 5 service providers based on the ranks.

6. The system of claim 5, wherein the service provider processor receives a client selection of one of the plurality of service providers to a selected service provider and presents a confirmation of appointment on the client graphical user interface.

7. The system of claim 5, wherein the service provider processor sends a confirmation of appointment to the client processor and displays the appointment on the client graphical user interface.

8. The system of claim 1 wherein the correlation score is calculated by the equation,
correlation score=(client preference data weight for time)×(ATV)+(client preference data weight for service provider rating)×(provider rating value)+(client preference data weight for location (distance between client and service provider))×(ADV)+client preference data weight for style×provider preference data style value.

9. A method for scheduling a haircut, the system comprising:
presenting a graphical user interface hosted on the web site server for sending and receiving client preference data from a client processor and provider preference data from a plurality of service provider processors;
receiving at a server data base the client preference data and service provider data from the graphical user interface;
storing by the server processor the client preference data and provider preference data in a data structure;
sending a pull request command sent by the server processor to plurality of the plurality of service provider processors when the server processor receives a service request message from the client processor through the graphical user interface, wherein the server processor sends the pull request to the plurality of service provider processors to cause the plurality service provider processors to respond to the pull request by sending updated service provider data to the server; and
sending a service appointment confirmation message to the client processor confirming an appointment with one of the plurality of service providers provider preference data based on a correlation score of the client preference data and the service provider the updated service provider data.

10. The method of claim 9, wherein the service provider data comprises categories for availability times, availability locations, services offered and price of service.

11. The method of claim 10, wherein the client preference data comprises client preference data categories comprising availability times, preferred locations, preferred service and price.

12. The method of claim 11, wherein each of the client preference data categories data are weighted by a client at the client processor, wherein the weights range numerically from 1.0 to 5.0 based on the importance of the service provider categories to the client and, wherein each of the client preference data and wherein the server processor correlates the service provider data with the client preference data categories to select a service provider to fulfil the client service request.

13. The method of claim 12, wherein the server processor ranks the service providers in order based a strength of the correlation of the service provider data categories and the client preference data categories and presents a top 5 service providers based on the ranks.

14. The method of claim 13, wherein the service provider processor receives a client selection of one of the plurality of service providers to a selected service provider and presents a confirmation of appointment on the client graphical user interface.

15. The method of claim 13, wherein the service provider processor sends a confirmation of appointment to the client processor and displays the appointment on the client graphical user interface.

16. The method of claim 9 wherein the correlation score is calculated by the equation,
correlation score=(client preference data weight for time)×(ATV)+(client preference data weight for service provider rating)×(provider rating value)+(client preference data weight for location (distance between client and service provider))×(ADV)+client preference data weight for style×provider preference data style value.

17. A computer readable medium comprising:
a computer program stored in a computer readable medium comprising instructions executed by a server processor, the computer program further comprising:
instructions to present a graphical user interface hosted on the web site server for sending and receiving client preference data from a client processor and provider preference data from a plurality of service provider processors;
instructions to receiving at a server data base the client preference data and service provider data from the graphical user interface;
instructions to store by the server processor the client preference data and provider preference data in a data structure;
instructions to send a pull request command sent by the server processor to plurality of the plurality of service provider processors when the server processor receives a service request message from the client processor through the graphical user interface, wherein the server processor sends the pull request to the plurality of service provider processors to cause the plurality service provider processors to respond to the pull request by sending updated service provider data to the server; and
instructions to send a service appointment confirmation message to the client processor confirming an appointment with one of the plurality of service providers provider preference data based on a correlation score of the client preference data and the service provider the updated service provider data.

18. The medium of claim 17, wherein the service provider data comprises categories for availability times, availability locations, services offered and price of service, wherein the client preference data comprises client preference data categories comprising availability times, preferred locations, preferred service and price and wherein each of the client preference data categories data are weighted by a client at the client processor, wherein the weights range numerically from 1.0 to 5.0 based on the importance of the service provider categories to the client and, wherein each of the client preference data and wherein the server processor correlates the service provider data with the client preference data categories to select a service provider to fulfil the client service request.

19. The medium of claim 18, wherein the server processor ranks the service providers in order based a correlation score for the service provider data categories and the client preference data categories and presents a top 5 service providers based on the correlation scores.

20. The medium of claim 19, wherein the service provider processor receives a client selection of one of the plurality of service providers to a selected service provider and presents a confirmation of appointment on the client graphical user interface.
